(19) United States
(12) Patent Application Publication
(10) Pub. No.: US 2025/0083760 A1
(43) Pub. Date: Mar. 13, 2025

(54) MODULAR KIT SYSTEM FOR CONVERTING A TRACTION DRIVE OF A MOTOR VEHICLE FROM AN INTERNAL COMBUSTION ENGINE TO AN ELECTRIC TRACTION DRIVE, SUPPORT STRUCTURE PROVIDED THEREFOR, MOTOR VEHICLE HAVING THE KIT SYSTEM, AND CONVERSION METHOD

(71) Applicant: E-R3VOLT GMBH, Dachau (DE)

(72) Inventor: Ralf SCHOLLENBERGER, Aschheim (DE)

(21) Appl. No.: 18/292,705

(22) PCT Filed: Jul. 28, 2022
(86) PCT No.: PCT/EP2022/071230

§ 371 Date: Jan. 26, 2024

(30) Foreign Application Priority Data
Jul. 28, 2021 (DE) 10 2021 119 577.2

(51) Int. Cl. B62D 65/10; B60K 1/02; B60K 1/04

(52) U.S. Cl. CPC B62D 65/10; B60K 1/02; B60K 1/04

(57) ABSTRACT

A modular kit system (14) for converting a traction drive (40) of a motor vehicle (10) from a drive having an internal combustion engine (11) to an electric traction drive (40). The kit (14) includes a mechanical support structure (15) having a mechanical connection interface (33) for fastening the support structure (15) in an engine compartment (12) of the motor vehicle (10) in place of the internal combustion engine (11), and electrical equipping components (16) for equipping the support structure (15), wherein the support structure (15) has equipment places (28) each for fastening one of the equipping components (16) in and/or on the support structure (15), and each equipment place corresponds, with respect to a form and/or a fastening device, with a form and/or a fastening device of a fastening region of the associated equipping component (16) for which the equipment place is provided.

Modular kit system for converting a traction drive of a motor vehicle from an internal combustion engine to an electric traction drive, support structure provided therefor, motor vehicle having the kit system and conversion method.

The invention relates to a modular kit system for converting a traction drive of a motor vehicle from a drive with internal combustion engine to an electric traction drive. A support structure, which can be used in the kit system, as well as a motor vehicle with electric traction drive and a conversion method also belong to the invention.

Up to now, cars (passenger cars) were developed, constructed and sold as combustion engine cars (gasoline engine/diesel engine cars), and they were operated until they could no longer be economically operated. The useful life of vehicles has been considerably extended in the last decades (according to study of the Institute CAR Duisburg: 25% of the vehicles in Germany are older than 15 years; the average age is at 9.6 years). Many of the today's vehicles are longer drivable from the technical status than a few years ago, the permanent durability or the rust protection has been greatly improved. Thus, body, chassis or attachment parts can be further used without problem.

A conversion of combustion engine cars to electric vehicles (EVs) currently occurs almost exclusively with older vehicles (before ca. year of manufacture 2005) without consideration of the existing electronics, especially the driver assistance systems (ADAS—Advanced Driver Assistance System). Here, it is a disadvantage that older vehicles have a lower expectable residual useful life upon regular use, and therefore the conversion would not be profitable anymore in many vehicles.

In addition, it is a disadvantage in the current conversion approaches that one always has to vehicle-individually newly develop/try out the attachment and arrangement of the new electrical drive components. This adaptation to other vehicles is time consuming. In addition, a separate individual approval by a technical inspection service (e.g. TÜV) respectively has to occur to obtain a vehicle permission for the converted motor vehicle, which is associated with corresponding time and financial expenditure.

The invention is based on the object to convert a motor vehicle, which comprises an internal combustion engine, into a purely electrically driven motor vehicle (electric vehicle).

As the solution, the invention provides the subject matters of the independent claims. Advantageous developments of these solutions are described by the dependent claims, the following description as well as the figures.

As one aspect, the invention includes a modular kit system for converting a traction drive of a motor vehicle from a drive with internal combustion engine to an electric traction drive.

The kit system (conversion kit) is provided, after disassembly or removal of the internal combustion engine in a motor vehicle, to equip the released engine compartment with an electric traction drive. Therein, the kit system is modular insofar as it is provided in individual parts or components, from which a selection can be made to form a certain or specific drive variant of the electric traction drive. Hereby, for example a passenger car can be converted as the motor vehicle, wherein other examples will be described in the following.

Hereto, the kit system includes:
a mechanical support structure with a mechanical connection interface for fastening the support structure in an engine compartment of the motor vehicle instead of the internal combustion engine; and
electrical equipping components for equipping the support structure, wherein a respective combination of at least some of the equipping components overall results in the said respective drive variant of the electric traction drive.

Herein, the support structure can present a mount or a rack, thus a standard attachment module, to which the selected equipping components from the kit system can be attached or fastened. The mechanical connection interface is preferably configured in the same manner as the internal combustion engine, which was previously arranged in the engine compartment, in the connection regions, where a contact with the walls of the engine compartment or chassis is provided. Hereto, for different chassis types or body types of motor vehicles, a correspondingly configured support structure with suitable connection interface for this body type or chassis type can respectively be provided (e.g. one suitable support structure per supported vehicle production series). Thus, the support structure in the engine compartment mechanically behaves like the internal combustion engine, if the connection of the support structure to the motor vehicle is concerned. For forming a certain or selected drive variant of the electric traction drive, the correspondingly required equipping components are then attached or fastened to the support structure. Such equipping components can be an electrical machine and power electronics for an electrical machine as will be further described.

The support structure comprises corresponding equipment places for fastening each one of the equipping components in and/or on the support structure. Therein, with respect to a shape and/or a fastening device, the respective equipment place is respectively configured corresponding to a shape and/or a fastening device of a fastening region (e.g. bottom region, side region) of the associated equipping component, for which the respective fastening place is intended. In other words, thus, for those equipping components, which are to be fastened to the support structure, a respective suitable equipment place is provided at the support structure. One equipment place can also be configured for two or more equipping components, wherein each only one thereof can then be arranged at the equipment place at the moment. Hereby, alternative drive variants can be formed in space saving manner by means of the support structure. The shape of the equipment place is adapted to the associated or intended equipping component insofar as a contact area of the equipment place for example fits to a bottom or a wall of the equipping component to be arranged thereon in that the two areas to be abutted to each other (of the equipment place and the equipping component) are for example flat. As the fastening device, for example a screw connection (screw thread, bore) and/or a buckle and/or a clip for bracing and/or a locking connection can for example be provided at an equipment place to fasten an equipping component to the equipment place. In particular, multiple different component models (for example different electrical machine models) can be provided of a respective equipping component, from which a user can then select a component model, which is to be installed in the support structure to obtain a certain drive variant.

By the invention, the advantage arises that upon converting a motor vehicle to an electric traction drive, a standardized reconstruction process with inspected components is performed or allowed by a standardizable support structure and a limited component set of equipping components, such that motor vehicles can be converted based on the kit system, without an individual case inspection subsequently having to be performed for each motor vehicle. Instead, it can be achieved that a type inspection and/or permission for the kit system can be sufficient to obtain permissible converted motor vehicles. The support structure and the equipping components can be developed and produced according to the standards of the car technology and thus represent retrofit components permitted in advance for a motor vehicle, which saves the individual case inspection. The kit system is modular insofar as a ready conversion motor as a replacement for the internal combustion engine is not delivered or provided, but the support structure can instead be optionally equipped with different equipping components to obtain different drive variants.

The invention also includes further characteristics, by which additional advantages arise.

It is particularly advantageous if the support structure can be completely or partially equipped in advance, thus before the support structure is inserted into the engine compartment. This simplifies the mounting. The completely or partially equipped support structure can also be introduced into the engine compartment with the already installed or attached equipping components without tilting due to the pre-equipment or the pre-equipped equipping components occurring. Thereby, an at least partial pre-equipment of the support structure outside of the motor vehicle is possible. Hereto, the equipment places for the corresponding equipping components can be correspondingly arranged or placed at the support structure.

In order to replace an internal combustion engine with an electric traction drive, further equipping components should also be provided in addition to an electrical machine. But also in context of electrical machines themselves, it can be provided that the kit system comprises multiple different machine models for providing different drive variants. Thus, at least one electrical machine is respectively provided of a machine model or multiple different machine models. As different machine models, it is here understood that different power classes and/or different technologies (for example reluctance/synchronous/asynchronous machine) are provided. Thus, the kit system can be based on a single machine model or on multiple different machine models. Herein, of each machine model, an equipment place or else also multiple equipment places for the simultaneous operation of multiple electrical machines can be provided in the support structure.

Furthermore, for supporting or for completing the electric traction drive, it is provided as the equipping component: of at least one assembly type, each at least one additional assembly for operating the at least one electrical machine. Herein, the term “assembly type” expresses that different additional assemblies are required, for example, it can respectively be provided as an assembly type: a current converter/inverter, an air conditioning compressor, a negative pressure pump. Of each provided assembly type, herein, at least one additional assembly can again respectively be provided, that is, an additional assembly or else multiple additional assemblies of the same assembly type can be provided in the support structure, which then support the one or more electrical machines and/or are driven by it.

With respect to the additional assemblies provided in addition to the electrical machine or the electrical machines, the following assembly types have in particular be recognized as relevant. Hereto, a development includes that at least one of the following assembly types is provided: power electronics (current converter, inverter), an electrical energy storage for storing drive energy, a charging device, a control device, a negative pressure pump, an air conditioning compressor, a heating assembly. Of each assembly type, it is preferably also respectively provided that different assembly models, for example different inverter models for current converters/inverters and/or different air conditioning compressors and/or different heating assemblies, are provided to make different drive variants with different equipment selectable for the user or capable of being generated in the support structure. For clarifying, it is here again emphasized that the “assembly type” describes different functions, thus for example the assembly types of current converter on the one hand and air conditioning compressor on the other hand. Then, one or more “assembly models” can be provided for each assembly type, thus the same function in different design, for example different assembly models of the assembly type “current converter”, which differ in the power class (for example 40 kW, 60 kW, 100 kW).

In and/or on the support structure, at least one equipment place is correspondingly respectively provided for each machine model and for each assembly type, wherein different machine models are in particular provided as respective alternative for different drive variants for alternative equipment. Thus, the support structure and the equipping components are matched to each other insofar as it is ensured in the selection of an equipping component that there is a corresponding equipment place, which is matched to this equipping component or corresponds to it with respect to the shape and/or the fastening device. For example, corresponding bores for inserting screws and/or locking elements for locking connections can be matched to each other. If multiple different machine models are provided, from which a user can select a machine model for a specific drive variant, thus, different alternative equipments can be correspondingly supported or provided by corresponding equipment places. In equipping the support structure, thus, there is preferably a unique arrangement for the equipping components, which is preset by the equipment places. This makes the mounting process-reliable.

With respect to the fastening of the support structure in the engine compartment, the already described mechanical connection interface is provided. It preferably provides that the support structure can be mechanically fastened in the engine compartment in the same manner as the previously disassembled internal combustion engine, that is the connection interface of the support structure simulates the connection interface of the internal combustion engine. Hereto, a development includes that the mechanical connection interface of the support structure corresponds to a mechanical connection interface for a predetermined body type of the motor vehicle in that the connection interface in particular comprises connection elements for at least one engine bearing and/or at least one engine bearing strut and/or at least one hydromount. In particular, it is provided that the support structure is designed for a predetermined body type, thus for example a preset vehicle model or a production series from a preset manufacturer as it can for example be identified by a production series designation. Thereby, corresponding connection points for the internal combustion engine and/or at least one other part, for example the so-called alternator (generator), are defined. If the connection interface of the support structure then also has the corresponding geometry and a fastening possibility, for example screw holes, for the same connection points or some of these connection points, thus, the advantage arises that the stiffness of the body of the motor vehicle is maintained by removing the internal combustion engine and inserting the support structure.

However, not only the support structure has to be connected to the motor vehicle, but it can also be provided in at least one equipping component, that it has to be mechanically and/or electrically connected to an existing component left in the motor vehicle, which has not been disassembled together with the internal combustion engine. Hereto, a development includes that at least one adapter of at least one adapter type for mechanically and/or electrically adapting at least one of the equipping components to a respective predetermined existing component of the motor vehicle is respectively provided. For example, it can be provided that an adapter is provided in the kit system to connect the shaft of an electrical machine to a flange of a manual transmission of the motor vehicle. For different transmissions, an adapter model of this adapter type (connection shaft to flange) can respectively be provided.

A development includes that in particular at least one of the following is provided as the adapter type:
a flange for connecting the electric traction drive to a manual transmission or an automatic transmission of the motor vehicle, and/or
an electrical terminating element for replacing an electrical component removed together with the internal combustion engine at a cable end of a cable of the motor vehicle, and/or
possibly remove here a simulation circuit since E-CAN module? for simulating an electrical component removed with the internal combustion engine during an operation of the electric traction drive after the conversion, and/or
a belt drive for coupling an air conditioning compressor to the electrical machine installed in the support structure, and/or
an adapter to the cooling system of the motor vehicle.

A terminating element can close an open cable end, which is left from the removed internal combustion engine or has been separated from it. A terminating element can electrically insulate the wires extending in the cable at the cable end from each other to thus for example avoid a short circuit. If the cable is a measurement line or a signal line for transferring an electrical signal, for example a coaxial cable, thus, a terminating resistor with a resistance value, which for example corresponds to the characteristic impedance of the cable, can also be provided as the terminating element, thus in a range of values from 5 Ohms to 100 Ohms, to mention just examples. If an air conditioning compressor is to be used as an existing component, thus, the drive, which has been provided by the internal combustion engine, then has to be replaced or provided by the installed electrical machine, whereto a suitable belt drive can be provided as the adapter. By means of an adapter for a cooling system, it can be achieved that cooling liquid from the cooling system of the motor vehicle can be used in the electrical machine for cooling for example the stator. By means of a simulation circuit, the presence of the internal combustion engine can be further “pretended” or simulated to a control device in the motor vehicle, which has been left as an existing component of the motor vehicle in it, by a simulation, for example to simulate and to signal a rotational speed course of the internal combustion engine by means of the simulation circuit. For example, the simulation circuit can be realized based on at least one microprocessor and/or at least one microcontroller. The simulation can provide that operating data of the electric traction drive, for example a rotational speed of an electrical machine, is mapped to simulated operating data of the internal combustion engine, thus, e.g. an operating temperature of the electric traction drive to a simulated temperature value of the internal combustion engine, a rotational speed of the electric traction drive to a simulated rotational speed of the internal combustion engine. Hereby, an algorithm or a circuit can be further operated in an existing component in the same manner as it has been effected in using or presence of the internal combustion engine, that is, an adaptation of the existing component to signals of the electric traction drive does not have to be effected since a conversion into corresponding signals of an internal combustion engine can be effected by the simulation circuit.

With respect to the configuration of the mechanical support structure, it can for example be achieved by a weight of the support structure adjusted by the construction that the total weight of the equipped support structure (support structure plus equipping components) for example corresponds to the total weight or the total mass of the internal combustion engine, in particular all of the removed predecessor components of the combustion drive, at least in a range from 80 percent to 120 percent of the mass, which corresponds to the disassembled mass of the internal combustion engine and/or further predecessor components (for example alternator). Hereby, a position of the center of gravity of the motor vehicle is maintained, which in particular maintains the drive dynamics of the motor vehicle.

A development includes that the support structure is completely or partially configured as a grid frame (“cage”) with one grid rod or multiple grid rods. A grid frame has the advantage that a heat accumulation in equipping components arranged in the interior of the support structure is avoided since air can freely flow from the inner equipment space to the outside. A grid structure or a grid frame also allows weight minimization of the support structure if this is desired. The equipment places for the equipping components can for example be formed in that a plate for placing a respective equipping component is fastened in the grid frame, for example by welding or by screwing. Generally, an equipment place can be realized by providing at least one screw hole/screw thread, at least one clip, at least one plate, at least one angular profile, at least one container or box, at least one loop to mention just examples.

In addition to the retaining function, it can also be achieved by the support structure that a so-called crash behavior of the motor vehicle after exchanging the internal combustion engine for the equipped support structure still remains unchanged or is at least maintained within the scope of the legal specifications. Hereto, a development includes that the grid frame comprises at least one curved rod and/or at least one rod with a wall thickness and/or diameter variably configured along its longitudinal extension direction and/or at least one rod with a structural weakening location. In other words, it can be provided that at least one rod does not have continuously the same thickness, but the wall thickness and/or the diameter of the rod is varied over the longitudinal extension. Hereby, for the temporal course of a crash, for example in an initial period of time, for example in the first 100 milliseconds or in the first 50 milliseconds, the impact behavior or the passage of an impact from the radiator grille for example towards the capturing sensor technology of an airbag triggering sensor in case of a frontal crash can be designed or predetermined. Hereby, it can then be ensured that an airbag and/or a belt pretensioner are triggered during the crash in the same manner as in case of the installed internal combustion engine (in particular at the same point of time or at a point of time, which is provided according to the legal regulations). In order to develop a corresponding grid frame with the described rods or at least one such rod, test series can for example be performed based on crash tests with dummies to ascertain a suitable arrangement and a suitable shape or configuration of at least one rod. By a curved rod, the impact force transferred along the longitudinal extension direction can be limited in that the rod curves or further bends transversely to the impact direction if an impact acts on the support structure in a frontal crash. A non-continuously same thickness and/or the provision of a weakening can ensure, at which location a rod first breaks or kinks if the rod is loaded with a predetermined minimum force in its longitudinal extension direction or transversely thereto.

In order to be able to drive an electric traction drive, an electrical energy storage is also required, in particular a high-voltage storage for providing an electrical DC voltage of greater than 60 Volts, in particular greater than 100 Volts. It can be that the engine compartment does not offer sufficient space to provide both the electric traction drive itself and an electrical energy storage. Hereto, a development includes that an energy storage unit is provided, which comprises installation spaces for battery modules, for an installation space of a fuel tank, in the area of the previous exhaust system, and/or spare wheel depression and/or a trunk of the motor vehicle, wherein an electrical terminal device or connection device is provided, which each provides an electrical connection to the electric traction drive both with full equipment and with partial equipment of the installation spaces of the energy storage unit with battery modules. Here, the realization is underlying that by removing the internal combustion engine, the fuel tank in the motor vehicle is also dispensable such that at least one battery module can be accommodated or installed in the installation space of the fuel tank. A trunk, in particular a compartment for the spare can, can also be used for accommodating or storing battery modules. The electrical connection device, which is provided hereto, can for example provide a housing, in which the battery modules can be installed. In that the connection device can variably provide both an electrical connection with full equipment (all of the provided installation spaces for battery modules are occupied in the energy storage unit) and with partial equipment, it is possible to first procure an energy storage unit with low storage capacity (by partial equipment of the installation spaces) and then to additionally purchase further battery modules at a later point of time, for example some months later, to obtain the full equipment or an extended partial equipment. The electrical connection device can for example include flexible cables to be able to lead the cables towards the installed battery modules. Thus, a further purchase of battery modules is possible, the energy storage unit does not have to be completely equipped.

An electrical machine can develop another torque course (torque over rotational speed) than an internal combustion engine. In order to here support the mechanical connection interface of the support structure with respect to the force transfer, at least one torque support can be formed at the support structure. Hereto, a development includes that a predetermined, spatial orientation of a rotational axis of a rotor of the electrical machine arises at the support structure by an equipment place for an electrical machine of the electric traction drive and the support structure comprises at least one support element, which protrudes from the support structure transversely or obliquely to this spatial orientation of the rotational axis, to rest and/or abut in the engine compartment as a torque support, e.g. on the chassis or the body. In other words, the torque support protrudes from the direction of the rotational axis perpendicularly or at least at an oblique angle (angle greater than 0 degrees, in particular greater than 45 degrees). Such a torque support can be formed at the support structure or protrude from the support structure as a support element for example in the form of a stud or angled sheet or a horn. The at least one support element can rest or abut on the adjoining body in the engine compartment such that upon an acceleration operation or also in case of a recuperation in a deceleration operation, the torque force originating from the stator of an electrical machine can be deflected or transferred into the body of the motor vehicle via the at least one support element. This supports the support structure in the engine compartment.

In order to be able to provide the kit system according to the invention, the described support structure is in particular required.

As a further aspect, therefore, the invention includes a support structure for an embodiment of the described kit system. The support structure comprises a mechanical connection interface for fastening the support structure in an engine compartment of a motor vehicle, in particular of a motor vehicle of a predetermined body type or chassis type (production series). In addition, the support structure comprises equipment places for fastening each one equipping component in and/or on the support structure. The respective equipment place is shaped for the respective equipping component, for which the respective fastening place is intended, each for abutting and/or locking the equipping component and/or comprises a fastening device for fastening the equipping component. The support structure can be configured in the described manner, thus e.g. at least partially as a grid frame. In order to configure the equipment places to the effect that a fastening device for a respective equipping component, thus for example for an electrical machine or for power electronics (inverter, current converter), is provided, a screw connection or screw holes, at least one buckle, at least one clip and/or a locking element for a locking connection can be provided to mention just examples.

Compared to a motor vehicle with an internal combustion engine, a further problem in electrifying a drive of a motor vehicle for providing an electric traction drive with high-voltage storage (greater than 60 Volts, in particular greater than 100 Volts) is the associated high-voltage cable for carrying the current from the energy storage unit to the electrical machine. The high-voltage cable should be laid or arranged considering EMC (electromagnetic compatibility). Hereto, a development includes that the support structure comprises a laying path for a high-voltage cable and a laying path for a data cable and/or for a cable of a low-voltage component, wherein the laying paths are arranged continuously spatially spaced by an interference suppression distance. Such a laying path can for example be realized by a color marking at the support structure, which dictates to an installer, along which laying path the high-voltage cable or the data cable and/or cable of the low-voltage component (low-voltage=electrical voltage less than 60 Volts) has to be laid. Herein, a color code can be used as it is known per se from the vehicle construction (for example yellow for airbag, orange for high-voltage). Additionally or alternatively to a color marking, the laying path can for example be provided by at least one clamp and/or at least one clip for securing or fastening the respective cable (high-voltage cable, data cable, cable of a low-voltage component). The said interference suppression distance is preferably at least 1 cm, in particular at least 3 cm, in particular at least 5 cm, in particular at least 7 cm. Thus, it is ensured that electromagnetic interference radiation from the high-voltage cable can penetrate a data cable and/or a cable of a low-voltage component only to an insignificant extent.

The invention also includes developments of the support structure as they have already been described in context of the developments of the kit system according to the invention, in particular providing at least one torque support.

As a further aspect, the invention includes a motor vehicle with an electric traction drive from the kit system, i.e. with the described support structure in the engine compartment. Thus, the motor vehicle according to the invention is in particular characterized in that it comprises an electric traction drive, in particular a purely electric traction drive, wherein precisely no internal combustion engine, but the described support structure in the equipped state is present in the engine compartment, thus, if corresponding equipping components are arranged on the support structure and/or in the support structure for a specific drive variant. A particularly preferred embodiment provides that the upper region of the support structure has a minimum distance to the closed hood arranged above, even if the support structure is installed in the engine compartment and equipped. This minimum distance is in particular more than 1 cm, preferably more than 2 cm, it should correspond to what was previously present, when the internal combustion engine was installed. Hereby, an effective pedestrian protection arises in case that a pedestrian hits the hood with the torso upon a collision.

Preferably, the motor vehicle according to the invention is configured as a car, in particular as a passenger car or truck or as a passenger bus or motorcycle or as an agricultural machine or as a construction machine.

The mounting of the motor vehicle upon use of the kit system results in a method, which is characterized in that a user can compose a drive variant based on the kit system, and this drive variant can then be installed in a motor vehicle as a replacement for an internal combustion engine. Here, it is to be noted that one selects the support structure suitable for the body type or chassis type of the motor vehicle to use the suitable mechanical connection interface. Thus, within the scope of the invention, one support structure or generally one kit system with the respectively suitable support structure can respectively be provided for different body types or chassis types. Then, a user can select the equipping components from the kit system based thereon, according to desired model, for example rated power of the electrical machine and/or the power electronics, and/or equipment with an air conditioning compressor to mention just examples. Then, the equipment of the support structure and inserting into the engine compartment are effected in the manner described in the following.

As a further aspect, the invention correspondingly includes a method for converting a motor vehicle by means of a kit system according to any one of the preceding claims, comprising the following steps:
depending on a manufacturer and/or chassis type (production series) of the motor vehicle, ascertaining the kit system with the support structure suitable for the engine compartment of the motor vehicle,
depending on a user selection of a drive variant, selecting equipping components for the selected drive variant from the kit system,
equipping the support structure with the selected equipping components, wherein equipping is effected by fastening the selected equipping components at a respective equipment place intended for them on and/or in the support structure,
removing at least the internal combustion engine from the engine compartment of the motor vehicle,
installing the support structure in the engine compartment instead of the internal combustion engine, wherein the installation is effected in the non-equipped or partially equipped or fully equipped state of the support structure.

Developments of the method according to the invention, which comprise features, as they have already been described in context of the developments of the motor vehicle according to the invention, also belong to the invention. For this reason, the corresponding developments of the method according to the invention are not again described here.

The invention also includes the combinations of the features of the described developments. Thus, the invention also includes realizations, which each comprise a combination of the features of multiple of the described embodiments if the embodiments have not been described as mutually exclusive.

In the following, embodiments of the invention are described. Hereto, there shows:

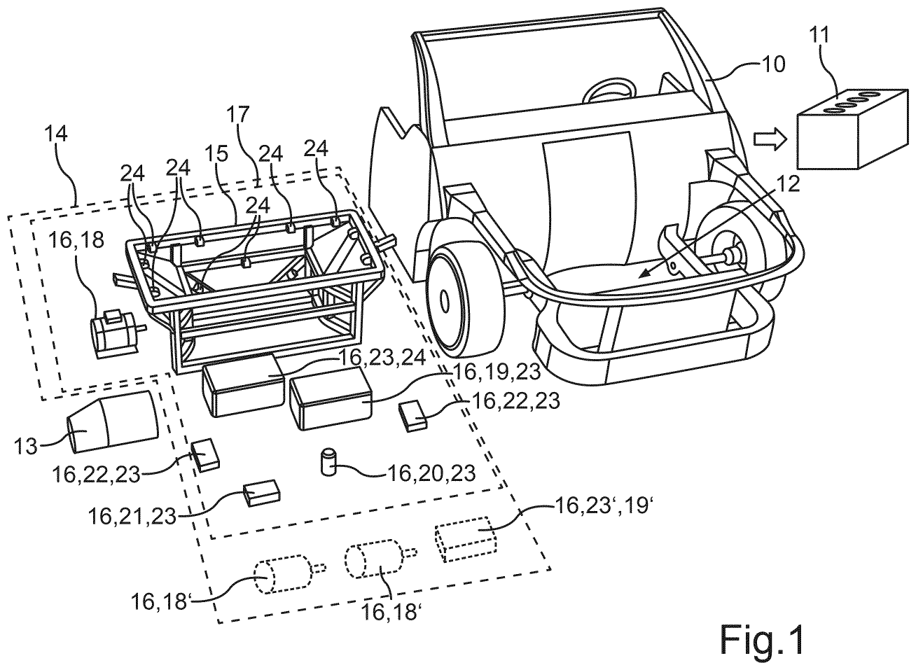

FIG. 1 a schematic representation of a motor vehicle, which is to be converted to an electric traction drive by means of an embodiment of the kit system according to the invention;

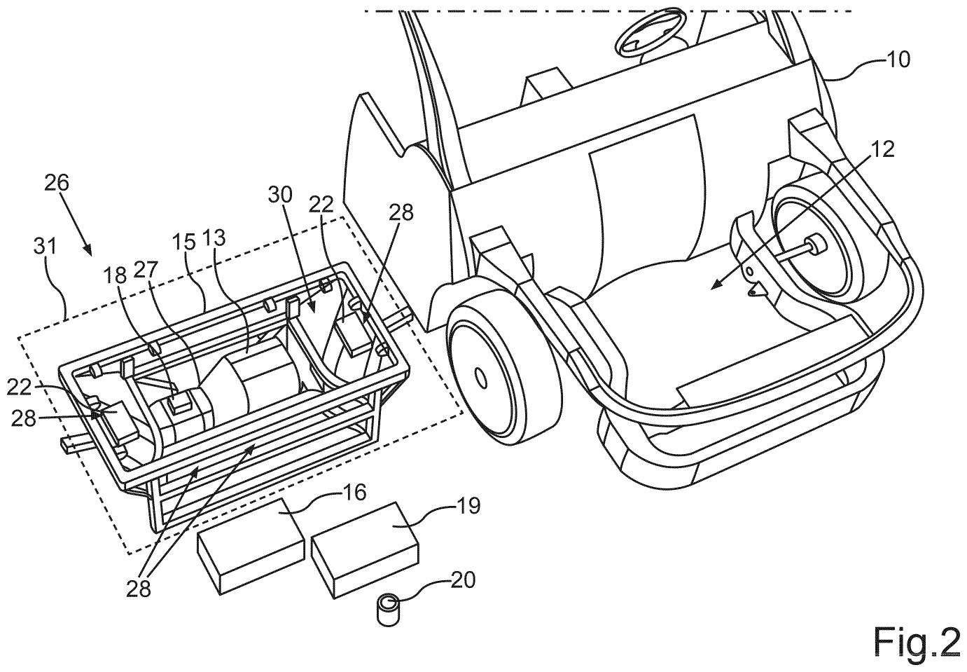

FIG. 2 a schematic representation of the motor vehicle of FIG. 1 and a support structure of the kit system in a partially equipped state;

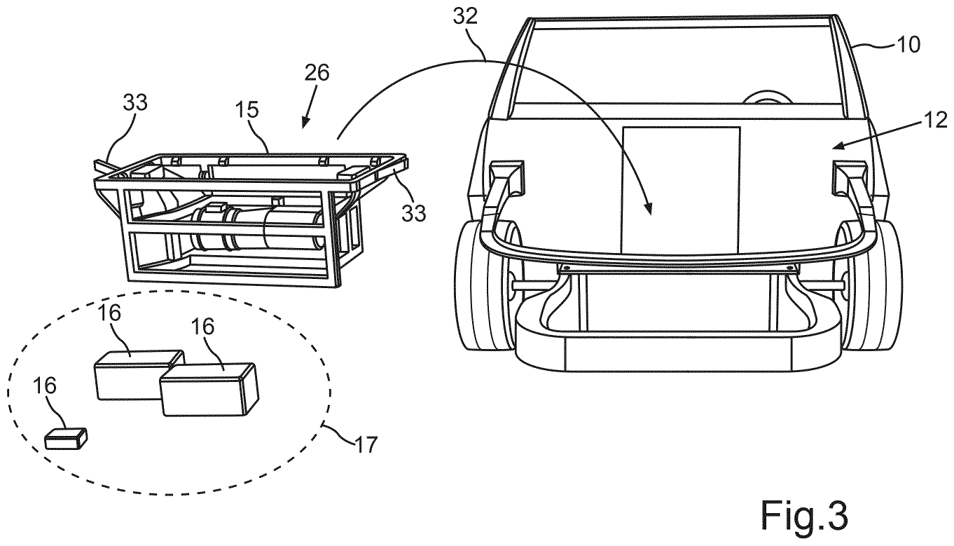

FIG. 3 a schematic representation of the motor vehicle during an installation of the partially equipped support structure;

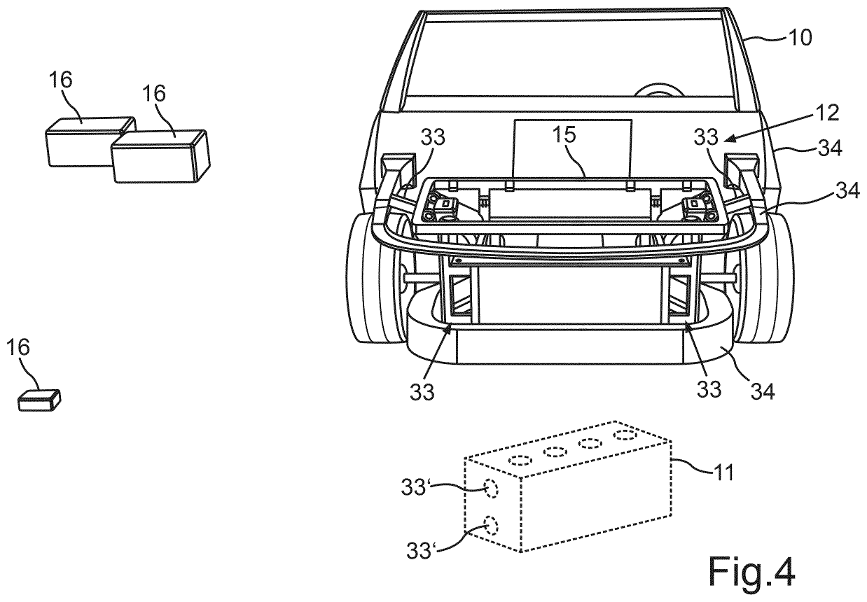

FIG. 4 a schematic representation of the motor vehicle with installed support structure during an installation of further equipping components;

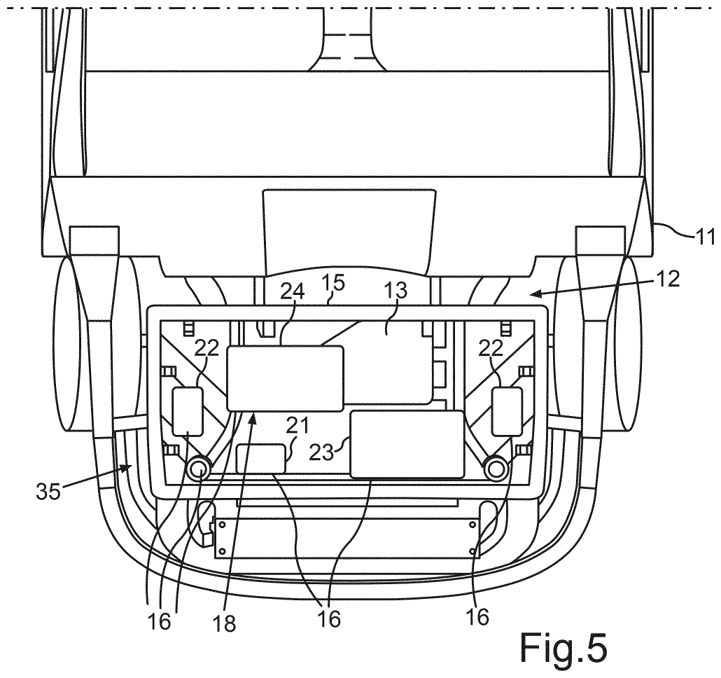

FIG. 5 a schematic representation of the motor vehicle with a resulting drive variant of an electric traction drive such that the motor vehicle represents an embodiment of the motor vehicle according to the invention;

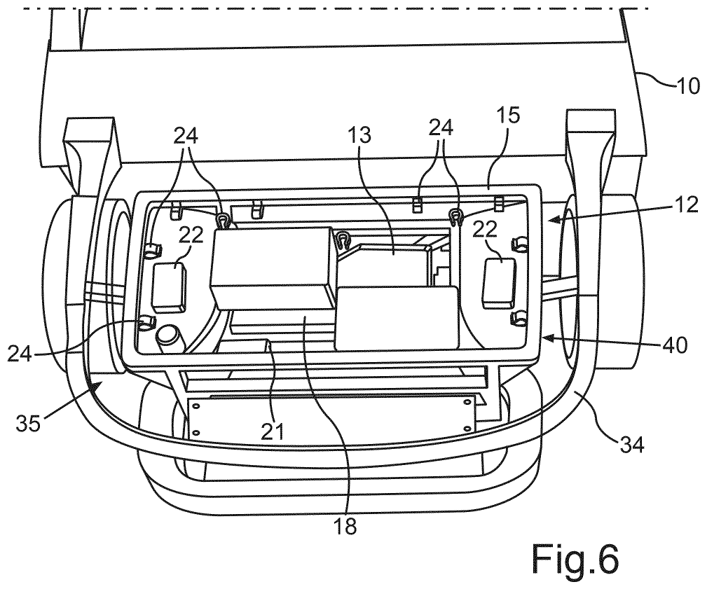

FIG. 6 a schematic representation of the embodiment of the motor vehicle according to the invention in a further perspective view;

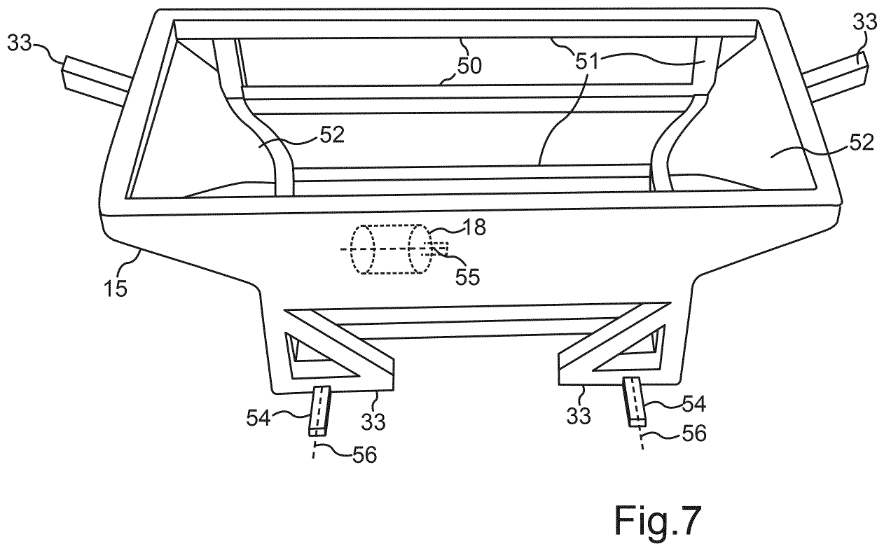

FIG. 7 a schematic representation of an embodiment of the support structure according to the invention in a perspective rear view;

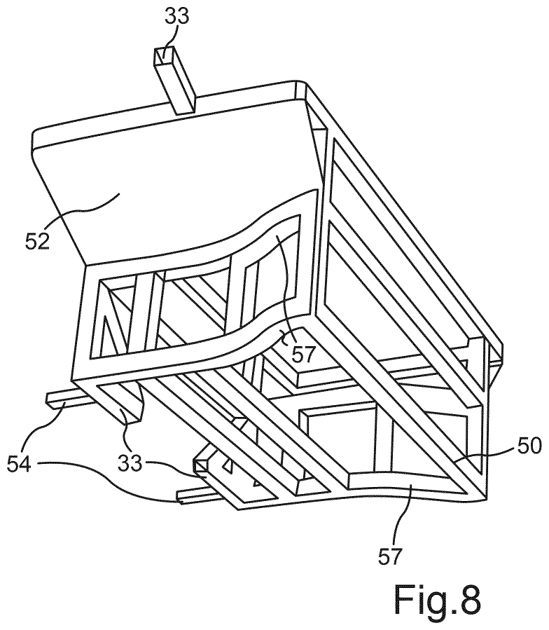

FIG. 8 a schematic representation of the support structure in a perspective view from diagonally below with respect to an intended installation position.

The execution examples explained in the following are preferred embodiments of the invention. In the execution examples, the described components of the embodiments each represent individual features of the invention to be considered independently of each other, which also each develop the invention independently of each other. Therefore, the disclosure also is to include combinations of the features of the embodiments different from the illustrated ones. Furthermore, the described embodiments can also be supplemented by further ones of the already described features of the invention.

In the figures, identical reference characters each denote functionally identical elements.

FIG. 1 shows a motor vehicle 10, which can for example be a passenger car or a truck. The motor vehicle 10 has comprised an internal combustion engine 11 in an engine compartment 12. In the state illustrated in FIG. 1, the internal combustion engine 11 has been disassembled to arrange an electric traction drive in the engine compartment 12, to thus convert the motor vehicle 10 from a traction drive with internal combustion engine 11 into a motor vehicle 10 with electric traction drive. In addition to the internal combustion engine 11, a transmission 13 (e.g. a manual transmission) can also have been disassembled, but which is to be also reused for the electric traction drive in the present example.

The electric traction drive can be formed based on a modular kit system 14 as will be described in the following.

The kit system 14 can include a support structure 15 and multiple equipping components 16, which can all be provided as separate elements or constituents of the kit system 14 for a user for selection. For example, the user can drive to a workshop with the motor vehicle 10 and there make a selection 17 of equipping components 16 from the kit system 14, based on which the electric traction drive is to be formed. As a respective equipping component 16, for example an electrical machine 18, power electronics 19, an electrical heating device 20, a simulator circuit 21 for simulating an electrical component, which has been disassembled together with the internal combustion engine 11, a control device 22 by the kit system 14 to mention just examples. To one or some or each of the equipping components 16, there can be at least one further equipping component of the same component type, but as different model in the kit system 14 for selecting. For example, to the electrical machine, at least one further machine model 18′ can be provided as an alternative for the selection 17. In context of the other equipping components 16, which do not represent an electrical machine, but additional assemblies 23, a further additional assembly 23′ of the same assembly type, but as a different or other or alternative assembly model can also respectively be provided. For example, it is illustrated in FIG. 1 that alternative power electronics 19′ can be provided to the power electronics 19 as an alternative additional assembly 23′, which the user can include in the selection 17 instead of the power electronics 19. The support structure and the equipping components can for example be offered to a user in a catalogue in a workshop or in a selection list in the Internet. Then, the user can make the selection 17 and a workshop can procure the selected parts and perform the conversion. Since they can be standardized retrofit components for motor vehicles and a standardized installation process (the arrangement of the support structure and of the equipping components is constructively set), the permission for the road traffic is associated with low effort.

The support structure 15 can be equipped with the selected equipping components 16 from the selection 17, to obtain a drive variant of an electric traction drive. Thereby, not each individual selected equipping component 16 has to be individually installed in the engine compartment 12, but an electric traction drive can be assembled and installed in the engine compartment 12 in a standardized manner by means of the support structure 15. Thereby, such an electric traction drive can also be provided with a permission, which does not have to be assigned for each individual reconstructed or converted motor vehicle 10 in an individual inspection. Instead, a permission can be effected for the kit system 14.

The kit system 14 can provide battery modules 25 for selection, only one of which is representatively illustrated in FIG. 1.

In or after equipping the support structure 15 with equipping components 16, it can additionally be ensured that a suitable laying path 24 is provided for at least one high-voltage cable on the one hand and at least one data cable (for the control devices 22 and/or the simulator circuit 21), and/or a low-voltage cable, which can for example be preset in the manner illustrated in FIG. 1 by clips or clamps for fastening or securing the cables.

FIG. 2 illustrates, how the electric traction drive can be formed in that the support structure 15 is first set into a partially equipped state before the support structure 15 is installed in the engine compartment 12. By the only partial or uncomplete equipment of the support structure 15, a partially equipped state 26 is achieved. Thus, at least a part of the mounting of the electric traction drive can thus be effected outside of the engine compartment 12. It is illustrated how the reused transmission 13 and the selected electrical machine 18 can be connected and inserted into the support structure 15. Herein, it can be provided that an adapter 27 is provided by the kit system 14, to for example fasten the electrical machine 18 to a flange of the transmission 13. Where the electrical machine 18 and/or the transmission 13 are to be fastened within the support structure 15, can be set or preset by prepared equipment places 28, at which for example suitable screw holes and/or fastening elements such as for example locking elements for locking connections are provided in the support structure 15.

In particular, it is provided that a reproducible and/or unique arrangement of the respectively selected equipping component 16 arises by the equipment places 28 for the equipping components 16 and the laying path 24 for the high-voltage cable on the one hand and the data cable and/or cable of a low-voltage component on the other hand.

Furthermore, FIG. 2 shows that it is achieved in the partially equipped state 26 by the already installed or fitted equipping components 16 due to the associated equipment places 28 that the equipping components only extend into an interior space or internal equipment space 30 of the support structure 15 such that the installed or fitted equipping components do not extend beyond an outer contour 31 of the support structure 15.

FIG. 3 illustrates how the support structure 15 in the partially equipped state 26 can be inserted or introduced into the engine compartment 12 of the motor vehicle 10 in an installation operation 32. Further equipping components 16 provided for equipping from the selection 17 can then be subsequently installed.

FIG. 4 illustrates how the support structure 15 in the engine compartment 12 can be fastened for example to a frame or chassis 34 of the motor vehicle 10 by means of a mechanical connection interface 33 in the engine compartment 12, for example in that the connection interface 33 is adapted for a screw connection. By corresponding selection or adaptation of a model of the support structure 15 to a model of a body type or a production series of the motor vehicle 10, it can be achieved that the mechanical connection interface 33 corresponds to a mechanical interface 33′ of the disassembled internal combustion engine 11, such that the support structure 15 can be fastened to the same connection points, which have been released by the disassembly of the internal combustion engine 11.

FIG. 5 illustrates in a top view how the remaining equipping components 16 from the selection 17 can also be installed in the support structure 15 after the installation of the support structure 15 such that it finally has a fully equipped state 35.

FIG. 6 illustrates the fully equipped state 35 with installed fully equipped support structure 15 in a view from diagonally above such that in contrast to FIG. 5, the electrical machine 18, cables arranged in the laying path 24 are not illustrated for the sake of clarity. In the installed state, the support structure 15 can for example be surrounded by the chassis 34 of the motor vehicle 10. In this state with installed fully equipped support structure 15, the motor vehicle 10 represents a converted motor vehicle 10 with electric traction drive 40.

FIG. 7 again illustrates the support structure 15 with the mechanical connection interface 33. The support structure 15 can be based on a grid frame 50, which can be formed by rods 51. Closed surfaces 52 can also be formed for example by sheets or plastic casings, which can present a splashguard for example with respect to the wheels of the motor vehicle. The support structure 15 can comprise at least one support element 54, which is oriented transversely or perpendicularly to an orientation of a rotational axis 55 of the electrical machine 18 in the installed state, that is a longitudinal extension direction 56 of the respective support element 54 can be oriented transversely or perpendicularly to the rotational axis 55. The support element 54 can for example be configured as a rod or bar. By means of the support element 54, a torque support for the electrical machine 18 can respectively be provided. The rods 51 can be configured curved for setting a crash behavior of the support structure 15 in the motor vehicle 10 and/or have a thickness and/or wall thickness variably or changeably configured along a respective longitudinal extension direction of the rods 51.

FIG. 8 again illustrates the grid structure or the grid frame 50 from a perspective from diagonally below. Furthermore, it is illustrated how curved rods 57 can be provided in the described manner.

Thus, modular hardware and software components are developed, which can be “docked” to the existing architecture of the basic vehicle. This is a one-time effort, which only has to be respectively adapted for each further vehicle architecture. The components to be newly installed are correspondingly prepared in unified manner and installed in the basic vehicle such that standardized procedures and fastening points can be used.

The electric motor (e-motor) is coupled to the drive in standardized manner and the E-CAN module connects the existing bus systems and control devices to the subsequently installed busses and control devices. Corresponding to the standardized engine suspension in vehicles of a production series, a standard attachment module is preferably employed as the support structure with mechanical connection interface, which adopts the retaining points. In the standard attachment module, the required control devices, e-motor and parts of the high-voltage system are then fastened according to a process-oriented arrangement method.

In other vehicle models, the retaining points of the standard attachment module are correspondingly adapted to the suspension points present in the vehicle, the arrangement of the control devices, high-voltage components and e-motor principally remain unchanged in the standard attachment module. If required, the arrangement with respect to the orientation (longitudinal/transverse) and the installation space is adapted to the model range or a new variant of the standard attachment module is generated, thus, only a different support structure is provided, but the equipping components remain identical in construction. The same retrofit components and fastening mechanisms in the respective standard attachment module are thus uniformly used.

The stock keeping can be efficiently effected since only few different component/modules have to be kept available. The modules can be uniformly, inexpensively premanufactured in high number of pieces. Thus, scale effects can be achieved and costs can be reduced. The approval by the technical inspection service can be simplified by a previous type inspection. A registration in the vehicle registration certificate is also preferably effected in unified manner. A guarantee can be more efficiently agreed since individual errors are reduced by a standardization of the components. In addition, it can be more intensively tested in the development since there are no individual variants. The susceptibility to errors in the development and in the installation in the workshop is greatly reduced by the standardization. The high number of the used standard components improves the purchase conditions and quality. Central premanufacture of the standard reconstruction module variants and uniform supply of the reconstruction workshops are possible.

This results in a standard attachment module for facilitated reconstruction of a combustion engine vehicle with standard components in short time. The premanufacture of the standard attachment modules with adaptations to the respective suspension points of the vehicle model series and prepared attachments for cable or lines as well as the standard components are provided. A process-oriented installation results by premanufactured uniform modules and preset conversion standards.

Overall, the examples show how a conversion kit for the mass production with global permission can be provided for converting a motor vehicle.

1. A modular kit system (14) for converting a traction drive (40) of a motor vehicle (10) from a drive with internal combustion engine (11) to an electric traction drive (40), comprising:
a mechanical support structure (15) with a mechanical connection interface (33) for fastening the support structure (15) in an engine compartment (12) of the motor vehicle (10) instead of the internal combustion engine (11);
electrical equipping components (16) for equipping the support structure (15), wherein a respective combination of at least some of the equipping components (16) overall results in a respective drive variant of the electric traction drive (40), wherein
the support structure (15) comprises equipment places (28) for fastening each one of the equipping components (16) in and/or on the support structure (15) and the respective equipment place is each configured with respect to a shape and/or a fastening device corresponding to a shape and/or a fastening device of a fastening region of the associated equipping component (16), for which the respective fastening place is intended.

2. The kit system (14) according to claim 1, wherein it is provided by the equipping components (16):
of at least one machine model (18′), each at least one electrical machine (18) and/or
of at least one assembly type, each at least one additional assembly (23) for operating the at least one electrical machine (18), and
at least one equipment place is respectively provided in and/or on the support structure (15) for each machine model (18′) and/or for each assembly type, wherein in particular different machine models (18′) are provided as a respective alternative for different drive variants for alternatively equipping.

3. The kit system (14) according to claim 2, wherein at least one of the following assembly types is provided: power electronics (19), an electrical energy storage for storing drive energy, a charging device, a control device (22), a negative pressure pump, an air conditioning compressor, a heating assembly.

4. The kit system (14) according to any one of the preceding claims, wherein the mechanical connection interface (33) of the support structure (15) corresponds to a mechanical connection interface (33) for a predetermined body type of the motor vehicle (10) in that the connection interface (33) in particular comprises a respective connection element for at least one engine bearing and/or for at least one engine bearing strut and/or for at least one hydromount.

5. The kit system (14) according to any one of the preceding claims, wherein at least one adapter (27) of at least one adapter type for mechanically and/or electrically adapting at least one of the equipping components (16) to a respective predetermined existing component of the motor vehicle (10) is respectively provided.

6. The kit system (14) according to claim 5, wherein at least one of the following is provided as the adapter type:
a flange for connecting the electric traction drive (40) to a manual transmission (13) or an automatic transmission (13) of the motor vehicle (10), and/or
an electrical terminating element for replacing an electrical component in particular removed together with the internal combustion engine (11) at a cable end of a cable of the motor vehicle (10), and/or
a simulation circuit for simulating an electrical component in particular removed with the internal combustion engine (11) during an operation of the electric traction drive (40) after the conversion, and/or
a belt drive (13) for coupling an air conditioning compressor to the electrical machine (18) installed in the support structure (15), and/or
an adapter (27) to a cooling system.

7. The kit system (14) according to any one of the preceding claims, wherein the support structure (15) is completely or partially configured as a grid frame (50) with at least one grid rod.

8. The kit system (14) according to claim 7, wherein the grid frame (50) comprises at least one curved rod and/or at least one rod with a wall thickness and/or diameter variably configured along its longitudinal extension direction (56) and/or at least one rod with a structural weakening location.

9. The kit system (14) according to any one of the preceding claims, wherein an energy storage unit is provided for an installation space of a fuel tank and/or a trunk of the motor vehicle (10), which comprises installation places for battery modules (25), wherein an electrical connection device is provided, which each provides an electrical connection to the electric traction drive (40) both with full equipment and with partial equipment of the installation places of the energy storage unit with battery modules (25).

10. The kit system (14) according to any one of the preceding claims, wherein a predetermined, spatial orientation of a rotational axis (55) of a rotor of the electrical machine (18) is preset in the support structure (15) by an equipment place for an electrical machine (18) of the electric traction drive (40) and the support structure (15) comprises at least one support element (54), which protrudes from the support structure (15) transversely or obliquely to this spatial orientation of the rotational axis (55), to in particular rest and/or abut in the engine compartment (12) as a torque support.

11. A support structure (15) for a kit system (14) according to any one of the preceding claims, wherein the support structure (15) comprises a mechanical connection interface (33) for fastening the support structure (15) in an engine compartment (12) of a motor vehicle (10) of a predetermined body type and equipment places (28) for fastening each one equipping component (16) in and/or on the support structure (15), wherein the respective equipment place for the respective equipping component (16), for which the respective fastening place is intended, is each shaped for abutting and/or for locking the equipping component (16) and/or comprises a fastening device for fastening the equipping component (16).

12. The support structure (15) according to claim 11, wherein the support structure (15) comprises a laying path (24) for a high-voltage cable on the one hand and a laying path (24) for a data cable and/or for a cable of a low-voltage component on the other hand, wherein the laying paths (24) are arranged continuously spatially spaced by a predetermined interference suppression distance.

13. A motor vehicle (10) with an electric traction drive (40) from a kit system (14) according to any one of claims 1 to 12 and/or with a support structure (15) according to claim 11 or 12 in the engine compartment (12).

14. The motor vehicle (10) according to claim 13, wherein, for obtaining a pedestrian protection in the closed state of a hood of the motor vehicle (10), the support structure (15) has a minimum distance to the closed hood arranged above, which is in particular more than 1 cm, preferably more than 2 cm.

15. A method for converting a motor vehicle (10) by means of a kit system (14) according to any one of the preceding claims, comprising the following steps:
depending on a manufacturer and/or body type of the motor vehicle (10), ascertaining the kit system (14) with the support structure (15) suitable for the engine compartment (12) of the motor vehicle (10),
depending on a user selection (17) of a drive variant, selecting (17) equipping components (16) for the selected drive variant from the kit system (14),
equipping the support structure (15) with the selected equipping components (16), wherein equipping is effected by fastening the selected equipping components (16) to a respective equipment place intended for them on and/or in the support structure (15),
removing at least the internal combustion engine (11) from the engine compartment (12) of the motor vehicle (10),
installing the support structure (15) in the engine compartment (12) instead of the internal combustion engine (11), wherein the installation is effected in the non-equipped or partially equipped or fully equipped state (26, 35) of the support structure (15).
